(19) United States
(12) Patent Application Publication
(10) Pub. No.: US 2009/0314128 A1
(43) Pub. Date: Dec. 24, 2009

(54) STEERING WHEEL FOR A MOTOR VEHICLE

(75) Inventor: Ulrich RICK, Roxheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/487,477

(22) Filed: Jun. 18, 2009

(30) Foreign Application Priority Data
Jun. 19, 2008 (DE) 102008029255.9
Jul. 28, 2008 (DE) 102008035104.0

(51) Int. Cl. B62D 1/06; B62D 1/04

(52) U.S. Cl. 74/558; 74/552

(57) ABSTRACT

A steering wheel is provided for a motor vehicle, having a hub area, a steering wheel rim, which is situated at least partially around this hub area, and a spoke for connecting the steering wheel rim to the hub area, the hub area, the spoke, and the steering wheel rim each being molded essentially from a high-strength plastic material and the steering wheel rim is implemented around the circumference of the steering wheel at least sectionally as a self-supporting hollow profile. Alternatively or additionally, the steering wheel rim is implemented around the circumference of the steering wheel at least sectionally as a self-supporting hollow profile made of a high-strength plastic material and is at least partially encapsulated with a steering wheel cover.

### CROSS-REFERENCE TO RELATED APPLICATIONS

This application claims priority to German Patent Application No. 102008029255.9, filed Jun. 19, 2008, and German Patent Application No. 102008035104.0, filed Jul. 28, 2008, which are incorporated herein by reference in their entirety.

### TECHNICAL FIELD

The present invention relates to a steering wheel for a motor vehicle, which has a hub area, a steering wheel rim, which is situated at least partially around the hub area, and at least one spoke for connecting the steering wheel rim to the hub area.

### BACKGROUND

Typical steering wheels are manufactured from a metal support as a support framework. The metal support is subsequently embedded using polyurethane foam, the gripping area may be additionally provided with grip-friendly envelopes made of wood, leather, etc.

This technology has proven itself for some time, but has disadvantages in regard to the production process. In particular the foaming process requires many foaming molds because of the relatively long foaming time, which is complex and costly for large-scale mass production in particular. In addition, chemical substances are released during the foaming process, which may damage the environment. These substances are needed, for example, as a propellant during the production of polyurethane foam. A further disadvantage of these typical steering wheels is their relatively high weight because of the metal support.

In addition to the typical requirements for a steering wheel such as sufficient rigidity and pleasant handling for the driver, the steering wheels for modern motor vehicles are frequently to fulfill further objects. It has become standard in the meantime to integrate an airbag in a steering wheel and also to provide further technical applications (e.g., operating and display elements) on the steering wheel. The construction of the steering wheel has therefore already been modified in manifold ways.

Thus, for example, DE 196 53 798 C1 describes a steering wheel for motor vehicles having an integrated airbag, which provides an essentially three-part steering wheel form to simplify the mounting and to increase the flexibility in regard to applications to be integrated. A metal skeleton as a support for all components to be mounted is enclosed in a sandwich together with all components fastened thereon by an upper shell and a lower shell made of plastic. In this way, a finished steering wheel may be provided, which only has to be put onto the steering column and fastened during the final installation.

A proposal for a lighter-weight steering wheel which is sufficiently dimensionally stable can be inferred from DE 30 38 820 A1. In this known steering wheel, the steering wheel rim is formed by an elastic hollow body, which is filled with high pressure gas and coated using a reinforced plastic.

A further steering wheel having reduced weight is disclosed in DE 298 02 474 U1. The complete steering wheel having hub area, spokes, and steering wheel rim is formed in this case from an upper shell and a lower shell, which are both manufactured from a high-strength plastic and permanently connected to one another. Because the two plastic shells do not form a self-supporting construction, at least the lower shell is reinforced with integrally molded-on webs, which project into the inner chamber between the two shells, to achieve the necessary non-deformability. However, these stiffening webs make the production of the steering wheel more complicated and also increase the weight of the steering wheel.

For the attachment of additional applications, steering wheels for motor vehicles are also known, which have one or more cavities to receive these applications.

Thus, for example, DE 198 38 452 C1 discloses a steering wheel having a steering wheel rim, which is at least sectionally provided with at least one cavity, which is open to a gripping area of the steering wheel rim through ventilation openings and in which a fan module is received for suctioning in air, so that the steering wheel rim may be temperature-controlled using simple means. The steering wheel rim is designed as a self-supporting hollow body, which is formed, for example, from two half shells which are connected to one another, a lower half shell being connected in the form of a metal plate to the support framework of the steering wheel and the upper half shell being implemented as a plastic injection-molded part.

At least one object of the present invention is to provide a steering wheel for a motor vehicle which has a low weight, is simple to produce, and avoids the disadvantages described above in regard to environmental strain. In addition, other objects, desirable features and characteristics will become apparent from the subsequent summary and detailed description, and the appended claims, taken in conjunction with the accompanying drawings and this background.

### SUMMARY

The steering wheel according to an embodiment of the invention for a motor vehicle has a hub area, a steering wheel rim, which is situated at least partially around this hub area, and at least one spoke for connecting the steering wheel rim to the hub area. It is provided that the hub area, the at least one spoke, and the steering wheel rim are each molded essentially from a high-strength plastic material, and the steering wheel rim is at least sectionally implemented as a self-supporting hollow profile along the peripheral direction of the steering wheel.

A significant weight reduction is possible through the implementation of the complete steering wheel from a high-strength plastic material, because a support framework in the form of a metal skeleton, for example, may be dispensed with. Through the at least sectional implementation of the steering wheel rim as a hollow profile, the weight and in particular also the moment of inertia of the steering wheel are decreased further. In spite of dispensing with the metal support framework, similarly good strengths and energy absorption properties may be achieved as in typical steering wheels using modern plastic materials. In addition, the complex and environmentally stressful foaming processes are dispensed with in the steering wheel constructed according to an embodiment of the invention.

The cavity formed by the hollow profile of the steering wheel rim may be additionally used if needed for further applications.

In a preferred embodiment, the steering wheel rim is at least partially encapsulated using a cover made of a plastic material (which is softer in particular than the high-strength plastic material of the steering wheel). By implementing essentially the entire steering wheel from plastic, this cover may especially advantageously be applied using a two-component injection molding method in a mold.

The steering wheel according to an embodiment of the invention for a motor vehicle has a hub area, a steering wheel rim situated at least partially around this hub area, and at least one spoke for connecting the steering wheel rim to the hub area. It is provided according that the steering wheel rim is implemented around the circumference of the steering wheel at least sectionally as a self-supporting hollow profile made of a high-strength plastic material, and the steering wheel rim is at least partially encapsulated using a cover made of a plastic material, which is softer in particular.

Through the implementation of the steering wheel rim as a self-supporting hollow profile made of a high-strength plastic material, the weight and in particular also the moment of inertia of the steering wheel are reduced. In spite of dispensing with a metal support framework, similarly good strengths and energy absorption properties may be achieved using modern plastic materials as in typical steering wheels. In addition, the complex and environmentally stressful foaming processes are dispensed with in the steering wheel constructed according to the invention. Through the implementation of the steering wheel rim from plastic, the cover may be applied in an especially simple way using a two-component injection molding method in a mold.

The first and the second aspects may preferably also be combined with one another. Preferably, at least two components, preferably all three components of the hub area, the at least one spoke, and the steering wheel rim are molded from the same plastic material. The further preferred designs of the steering wheel therefore relate to both the steering wheel according to the above first aspect and also to the steering wheel according to the above second aspect and to a steering wheel according to the first and second aspects.

In one embodiment of the steering wheel according to the invention, the hollow profile of the steering wheel rim is implemented in one piece and is integrally molded with the at least one spoke.

In an alternative embodiment of the steering wheel according to the invention, the hollow profile of the steering wheel rim is formed from two or more shell parts, at least one of these at least two shell parts being integrally molded with the at least one spoke.

In this variant, at least two shell parts of the hollow profile of the steering wheel rim may be formed from different materials having specific optic and/or haptic properties. In addition, the at least two shell parts of the hollow profile are preferably connected to one another positively or non-positively, and/or are materially bonded to one another. Two shell parts may in particular be welded, glued, and/or clipped to one another.

In a further preferred design of the invention, the steering wheel rim may also be provided with a cover, in particular made of leather, textiles, or the like.

In the steering wheel according to the invention having the construction described above, the components of the steering wheel manufactured from the high-strength plastic are preferably produced using an injection molding method. The encapsulation of the steering wheel rim with a steering wheel cover made of a softer plastic material may then be performed particularly advantageously using a two-component injection molding method.

### BRIEF DESCRIPTION OF THE DRAWINGS

The present invention will hereinafter be described in conjunction with the following drawing figures, wherein like numerals denote like elements, and:

FIG. 1a shows a top view of a steering wheel according to an embodiment of the present invention;

FIG. 1b shows a sectional view along line X-X in FIG. 1a in an enlarged exploded illustration according to a first embodiment of the present invention;

FIG. 1c shows a sectional view along line X-X in FIG. 1a in an enlarged illustration according to the first embodiment;

FIG. 2 shows a sectional illustration corresponding to FIG. 1c according to a second embodiment of the steering wheel according to the invention;

FIG. 3 shows a sectional illustration corresponding to FIG. 1c according to a third embodiment of the steering wheel according to the invention; and

FIG. 4 shows a sectional illustration corresponding to FIG. 1c according to a fourth embodiment of the steering wheel according to the invention.

### DETAILED DESCRIPTION

The following detailed description is merely exemplary in nature and is not intended to limit application and uses. Furthermore, there is no intention to be bound by any theory presented in the preceding background and summary or the following detailed description.

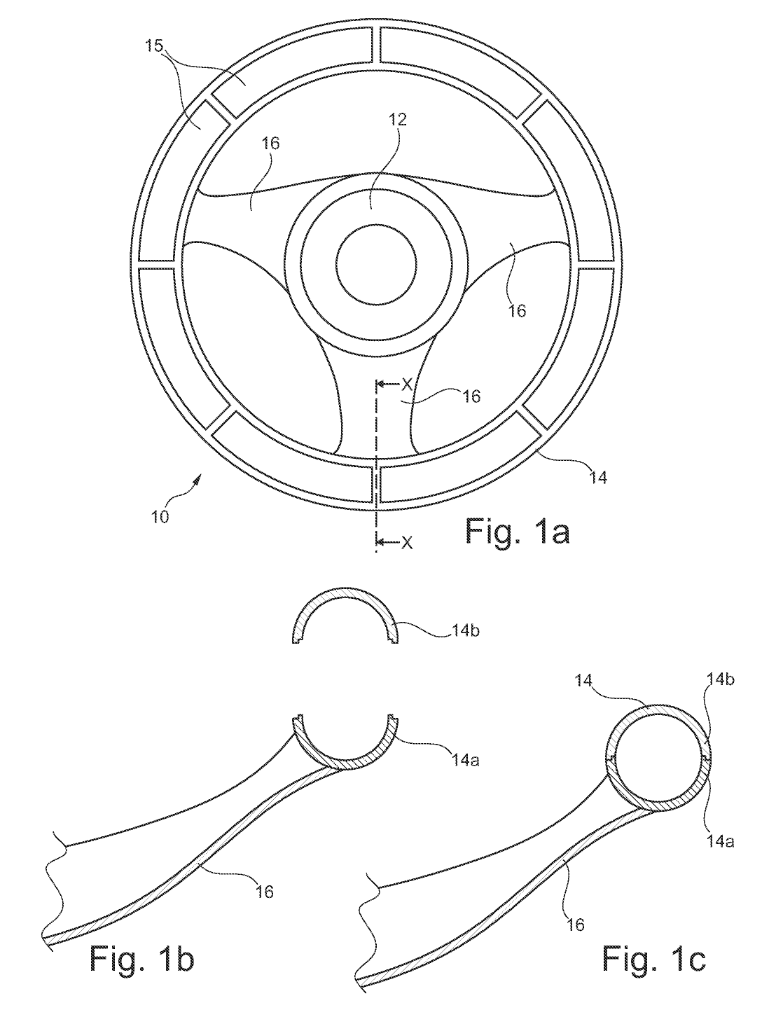

In partial FIG. 1a, FIG. 1 shows a steering wheel 10 according to an embodiment of the invention for a motor vehicle in a top view, which approximately corresponds to the perspective of a driver of the steering wheel. The steering wheel 10 comprises an essentially central hub area 12, which is fastened on the steering column of the motor vehicle, and a steering wheel rim 14 situated around it. In the exemplary embodiment of FIG. 1, this steering wheel rim 14 extends entirely around the central hub area 12. The present invention is not restricted to this embodiment, however; the steering wheel rim 14 may also only extend partially (e.g., over an angle range of approximately 220° to approximately 270°) around the hub area 12. Although a steering wheel 10 having an essentially circular steering wheel rim 14 is shown in FIG. 1 as an example, the present invention is not restricted thereto; for example, steering wheel rims having an elliptical, polygonal, or similar form may also be used.

In the exemplary embodiment of FIG. 1, the steering wheel rim 14 contains a total of eight segments 15, which are distributed uniformly around the circumference of the steering wheel 10. However, the present invention is not restricted to this embodiment; the steering wheel rim 14 may fundamentally have any arbitrary number of segments 15, in particular it may also be formed from only one segment 15, which extends over the entire steering wheel rim 14. Furthermore, the individual segments 15 of the steering wheel rim 14 do not necessarily all have to have the same size and shape.

The steering wheel rim 14 in FIG. 1a is connected to the central hub area 12 via three spokes 16. The three spokes 16 extend from the central hub area 12 essentially radially outward (see partial FIG. 1a)) and diagonally upward in the direction toward the driver (see partial FIG. 1b and FIG. 1c)). The present invention is not only restricted to this embodiment, however, the steering wheel rim 14 may also be connected to the hub area 12 using only one spoke, using two spokes, or using more than three spokes 16. The shape, the size, and the orientation of the spokes 16 are also not restricted to the embodiment shown in FIG. 1.

Although it is not shown in partial FIG. 1a, an airbag or airbag module may also be integrated and/or received in the hub area 12 of the steering wheel 10.

The hub area 12, the steering wheel rim 14, and the spokes 16 of the steering wheel are manufactured from a high-strength plastic material, preferably from the same plastic material in each case using injection molding. A suitable high-strength plastic material is a plastic material based on polycarbonate, for example, in particular a modified polycarbonate. Using such a plastic material, similar strength and energy absorption properties may be achieved as with a typical steering wheel construction having metal skeleton.

As shown in partial FIG. 1b and FIG. 1c, the steering wheel rim 14 is constructed from a lower shell part 14a and an upper shell part 14b and is thus designed as a hollow profile. The two shell parts 14a and 14b are connected to one another positively or non-positively, and/or are materially bonded to one another, preferably permanently connected to one another. Suitable connection techniques are, for example, welding, gluing, clipping, crimping, catching, and the like.

In the embodiment of FIG. 1a and FIG. 1b, the lower half shell part 14a is preferably implemented integrally with one of the spokes 16. Alternatively, however, a two-part design using a suitable connection technique is also possible. The hub areas 12 and the spoke(s) 16 are preferably also implemented integrally with one another. In this way, a steering wheel 10 having few individual parts is provided, which may thus be produced and mounted in a motor vehicle simply.

The steering wheel rim 14 may alternately be implemented having such a hollow profile over the entire circumference of the steering wheel 10 or only have such a hollow profile sectionally. For example, only individual segments 15 or all segments 15 of the steering wheel rim 14 are implemented having the design illustrated in partial FIG. 1b and FIG. 1c.

Furthermore, it is also possible to manufacture the steering wheel rim 14 from more than two shell parts 14a, 14b, preferably at least one of the shell parts being molded integrally with the particular spokes 16. In addition, the at least two shell parts 14a, 14b of the steering wheel rim 14 do not necessarily have to cover the same angle range in each case (approximately 180° each for two shell parts, approximately 120° each for three shell parts, etc.), but rather may also have different sizes. Thus, for example, the lower shell part 14a may cover an angle range of approximately 150° to approximately 270°, while the upper shell part 14b only covers an angle range from approximately 90° to approximately 210°, for example.

If needed, further technical applications may be integrated in the steering wheel in the cavity of the steering wheel rim 14, which is formed by the hollow profile. For example, the cavity may be used for measures for the temperature control of the steering wheel rim, in this case, additional ventilation openings in able to be provided in the upper shell part 14b of the steering wheel rim. Furthermore, the integration of lighting means in the steering wheel rim 14 is also possible, in this case, the upper shell part 14b being implemented as at least partially transparent or being provided with transparent openings. Furthermore, operating elements, display elements, and/or components of these elements may also be received in the cavity of the steering wheel rim 14.

In a modification of the embodiment of the steering wheel 10 according to the invention shown in FIG. 1, the upper shell part 14b of the hollow profile of the steering wheel rim 14 may be formed from a different material having specific optic and/or haptic properties. For example, the upper shell part 14b facing toward the driver may contain other plastic materials, wood, metal, stone, carbon, and the like, in order to make the steering wheel higher-value and provide it with an improved appearance and gripping feel.

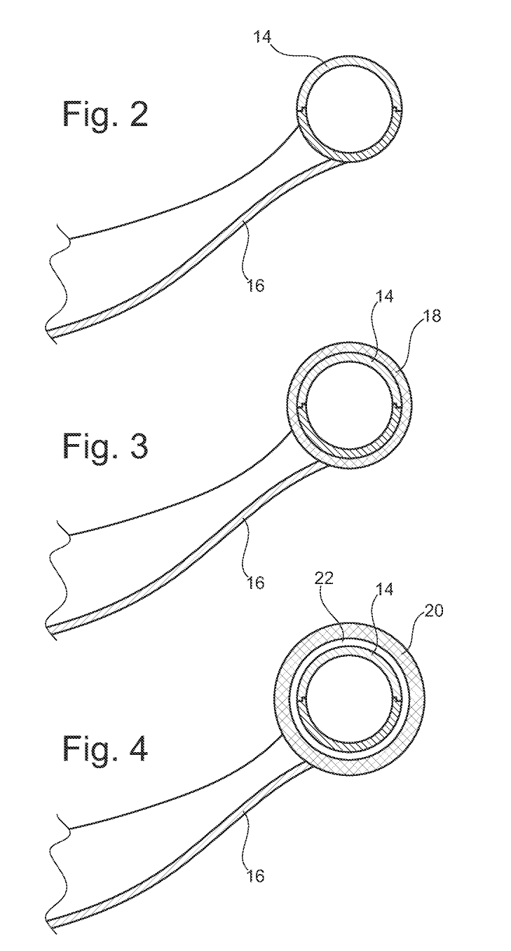

FIG. 2 shows a second exemplary embodiment of a steering wheel 10 according to the invention. FIG. 2 corresponds to the illustration of FIG. 1c, the remaining components of the steering wheel 10 are constructed similarly to the first exemplary embodiment of FIG. 1.

The second embodiment differs from the first embodiment explained above on the basis of FIG. 1b and FIG. 1c in that the hollow profile of the steering wheel rim 14 is not formed by two or more shell parts 14a, 14b, but rather is implemented in one piece. The hollow steering wheel rim 14 and/or the hollow sections of the steering wheel rim 14 may advantageously be injected hollow in one piece using injection molding.

The remaining features and their variants correspond to those of the above first exemplary embodiment.

A third embodiment of a steering wheel 10 according to the invention will now be explained with reference to FIG. 3. FIG. 3 corresponds to the illustration of FIG. 1c, the remaining components of the steering wheel 10 are constructed similarly to the first exemplary embodiment of FIG. 1.

As shown in FIG. 3, the steering wheel rim 14 is provided with a cover 18. This cover 18 comprises a soft plastic material, in particular a plastic material which is softer than the high-strength plastic of the hollow profile of the steering wheel rim. Using this cover 18, depending on the selection of the material, the optics, the grip, and/or the haptics of the steering wheel rim 14 may be improved (or generally influenced).

In the illustration of FIG. 3, the cover 18 extends over the entire circumference of the steering wheel rim 14. It is also alternately possible to envelop the steering wheel rim 14 only partially with such a cover 18.

Furthermore, the steering wheel rim 14 may be provided with the cover 18 both in the sections in which it is implemented as a hollow profile and also in the remaining sections. Moreover, the cover 18 may alternately also extend over further sections of the steering wheel 10, for example, also over the spokes 16.

The hollow profile 14a, 14b of the steering wheel rim 14 is preferably encapsulated by the cover 18. For this purpose, a two-component technology is advantageously used, in which the hollow profile 14 and the cover 18 may be manufactured in sequence in the same mold.

Of course, this third exemplary embodiment can also be combined with the second embodiment of the steering wheel 10 of FIG. 2.

With reference to FIG. 4, a fourth embodiment of a steering wheel 10 according to the invention is now described in greater detail. FIG. 4 corresponds to the illustration of FIG. 1c, the remaining components of the steering wheel 10 are constructed similarly to the first exemplary embodiment of FIG. 1.

As shown in FIG. 4, the steering wheel rim 14 is provided with a cover 20. This cover 20 comprises leather, textiles, or the like, in order to make the steering wheel 10 higher-value.

In the illustration of FIG. 3, the cover 18 extends over the entire circumference of the steering wheel rim 14. It is alternately also possible to envelop the steering wheel rim 14 only partially with such a cover 18.

Optionally, a cushion layer 22 made of a foam, a softer plastic, as described in the third embodiment, or the like may also be situated between the hollow profile of the steering wheel rim and this cover 20, in order to improve the grip sensitivity of the steering wheel 10 for the driver.

Similarly to the exemplary embodiment of FIG. 3, the steering wheel rim 14 may optionally also be provided with the cover 20 in the sections in which it is implemented as a hollow profile, and also in the remaining sections. In addition, the cover 20 may alternately also extend over further parts of the steering wheel 10.

Of course, this fourth exemplary embodiment may also be combined with the second embodiment of the steering wheel 10 of FIG. 2 and/or the third embodiment of the steering wheel 10 of FIG. 3.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A steering wheel for a motor vehicle, comprising:
a hub area;
a steering wheel rim that is situated at least partially around the hub area; and
a spoke for connecting the steering wheel rim to the hub area;
wherein the hub area, the spoke, and the steering wheel rim are each molded essentially from a high-strength plastic material, and
wherein the steering wheel rim is implemented at least sectionally as a self-supporting hollow profile around a circumference of the steering wheel.

2. The steering wheel according to claim 1, wherein the steering wheel rim is at least partially encapsulated using a cover made of a plastic material.

3. The steering wheel according to claim 1, wherein at least two of the hub area, the spoke, and the steering wheel rim are molded from the same plastic material.

4. The steering wheel according to claim 1, wherein the self-supporting hollow profile of the steering wheel rim is implemented in a single piece and integrally molded with the spoke.

5. The steering wheel according to claim 1, wherein the self-supporting hollow profile of the steering wheel rim is formed from at least two shell parts, at least one of the at least two shell parts being molded integrally with the spoke.

6. The steering wheel according to claim 5, wherein the at least two shell parts are formed from different materials having specific optic property.

7. The steering wheel according to claim 5, wherein the at least two shell parts are formed from different materials having specific haptic property.

8. The steering wheel according to claim 5, wherein the at least two shell parts are materially bonded to one another.

9. The steering wheel according to claim 1, further comprising a cover for the steering wheel rim.

10. A steering wheel for a motor vehicle, comprising:
a hub area;
a steering wheel rim that is situated at least partially around the hub area; and
a spoke for connecting the steering wheel rim to the hub area,
wherein the steering wheel rim is implemented along a peripheral direction of the steering wheel at least sectionally as a self-supporting hollow profile made of a high-strength plastic material, and
wherein the steering wheel rim is at least partially encapsulated using a cover made of a plastic material.

11. The steering wheel according to claim 10, wherein at least two of the hub area, the spoke, and the steering wheel rim are molded from the plastic material.

12. The steering wheel according to claim 10, wherein the self-supporting hollow profile of the steering wheel rim is implemented in a single piece and integrally molded with the spoke.

13. The steering wheel according to claim 10, wherein the self-supporting hollow profile of the steering wheel rim is formed from at least two shell parts, at least one of the at least two shell parts being molded integrally with the spoke.

14. The steering wheel according to claim 13, wherein the at least two shell parts are formed from different materials having specific optic property.

15. The steering wheel according to claim 13, wherein the at least two shell parts are formed from different materials having specific haptic property.

16. The steering wheel according to claim 13, wherein the at least two shell parts are materially bonded to one another.
